(19) United States
(12) Patent Application Publication
(10) Pub. No.: US 2026/0118716 A1
(43) Pub. Date: Apr. 30, 2026

(54) DISPLAY DEVICE AND HEAD-UP DISPLAY APPARATUS

(71) Applicant: Panasonic Automotive Systems Co., Ltd., Kanagawa (JP)

(72) Inventors: Hiroki HARA, Kanagawa (JP); Satoshi MIKAYAMA, Kanagawa (JP); Noritaka TANABE, Osaka (JP); Yusuke YONETANI, Hyogo (JP); Daiki KAWAI, Kanagawa (JP)

(73) Assignee: Panasonic Automotive Systems Co., Ltd., Kanagawa (JP)

(21) Appl. No.: 19/332,710

(22) Filed: Sep. 18, 2025

(30) Foreign Application Priority Data
Oct. 31, 2024 (JP) 2024-192071

(51) Int. Cl. G02F 1/1335; G02B 27/00; G02B 27/01; G02F 1/13357

(52) U.S. Cl. CPC G02F 1/133607; G02B 27/0037; G02B 27/0101; G02F 1/133605; G02F 1/133611; G02B 2027/011; G02B 2027/013

(57) ABSTRACT

A display device includes a backlight device and a display panel. The backlight device includes a plurality of light sources arranged in a two-dimensional array and a plurality of optical elements having a one-to-one correspondence with the plurality of light sources. The display panel outputs an image on the basis of light emitted by the backlight device. Each of the plurality of optical elements has positive power. The plurality of optical elements include (i) optical elements on the outer side located in at least a portion of an outer peripheral area that is within an area where the plurality of optical elements are arranged and (ii) optical elements on the inner side located inward from the optical elements on the outer side. The power of an optical element on the outer side differs from the power of an optical element on the inner side.

### CROSS REFERENCE TO RELATED APPLICATION

The present application is based on and claims priority of Japanese Patent Application No. 2024-192071 filed on Oct. 31, 2024.

### FIELD

The present disclosure relates to a display device and a head-up display apparatus.

### BACKGROUND

A display device used in a head-up display apparatus is conventionally known. A display device outputs an image displayed on a display area of a display panel to an external destination. A head-up display apparatus displays a virtual image of the image output by the display device on the windshield of a vehicle, with the virtual image being superposed on a scene in front of the vehicle. Patent Literature (PTL) 1 discloses a liquid crystal display apparatus that is an example of a display device.

### CITATION LIST

### Patent Literature

PTL 1: Japanese Patent No. 7231832

### SUMMARY

However, the display device disclosed in PTL 1 can be improved upon.

In view of this, the present disclosure provides, for example, a display device capable of improving upon the above related art.

A display device according to one aspect of the present disclosure includes: a backlight device including: a plurality of light sources arranged in a two-dimensional array; and a plurality of optical elements having a one-to-one correspondence with the plurality of light sources; and a display panel that outputs an image based on light emitted by the backlight device, in which each of the plurality of optical elements has power that is positive, the plurality of optical elements include (i) an optical element on an outer side located in at least a portion of an outer peripheral area that is within an area where the plurality of optical elements are arranged and (ii) an optical element on an inner side located inward from the optical element on the outer side, and the power of the optical element on the outer side differs from the power of the optical element on the inner side.

A display device according to another aspect of the present disclosure includes: a backlight device including: a plurality of light sources arranged in a two-dimensional array; and a plurality of optical elements having a one-to-one correspondence with the plurality of light sources; and a display panel that outputs an image based on light emitted by the backlight device, in which each of the plurality of optical elements has power that is positive, the plurality of optical elements include (i) an optical element on an outer side located in at least a portion of an outer peripheral area that is within an area where the plurality of optical elements are arranged and (ii) an optical element on an inner side located inward from the optical element on the outer side, and a distance between an optical axis of the optical element on the outer side and an optical axis of the optical element on the inner side adjacent to the optical element on the outer side differs from a distance between optical axes of two adjacent optical elements on the inner side, each being the optical element on the inner side.

A display device according to another aspect of the present disclosure includes: a backlight device including: a plurality of light sources arranged in a two-dimensional array; and a plurality of optical elements having a one-to-one correspondence with the plurality of light sources; and a display panel that outputs an image based on light emitted by the backlight device, in which each of the plurality of optical elements has power that is positive, the plurality of light sources include (i) a light source on an outer side located in at least a portion of an outer peripheral area that is within an area where the plurality of light sources are arranged and (ii) a light source on an inner side located inward from the light source on the outer side, and a light-emitting size of the light source on the outer side differs from a light-emitting size of the light source on the inner side.

A head-up display apparatus according to another aspect of the present disclosure includes the above display device.

A display device and the like according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates a backlight device and a display panel included in a display device in comparison example 1.

FIG. 2 illustrates an example of a display area of a display device included in a first vehicle.

FIG. 3 illustrates an example of a display area of a display device included in a second vehicle.

FIG. 4 illustrates an example of a display area of a display device in comparison example 2.

FIG. 5 illustrates a backlight device and a display panel included in a display device in the present disclosure.

FIG. 6 illustrates an example of a display area of the display device in the present disclosure.

FIG. 7 illustrates a vehicle provided with a head-up display apparatus according to Embodiment 1.

FIG. 8 illustrates an area of a windshield on which an HUD image is to be displayed by the head-up display apparatus according to Embodiment 1.

FIG. 9 illustrates a configuration of the head-up display apparatus according to Embodiment 1.

FIG. 10 illustrates a backlight device and a display panel included in a display device in Embodiment 1.

FIG. 11 illustrates an optical element on the outer side included in the backlight device in Embodiment 1.

FIG. 12 illustrates an optical element on the outer side included in a backlight device in Variation 1 of Embodiment 1.

FIG. 13 illustrates a backlight device and a display panel included in a display device in Variation 2 of Embodiment 1.

FIG. 14 illustrates a light source and an optical element on the outer side that are included in the backlight device in Variation 2 of Embodiment 1.

FIG. 15 illustrates a backlight device and a display panel included in a display device in Variation 3 of Embodiment 1.

FIG. 16 illustrates a light source on the outer side included in the backlight device in Variation 3 of Embodiment 1.

FIG. 17 illustrates a backlight device and a display panel included in a display device in Variation 4 of Embodiment 1.

FIG. 18 illustrates an optical element on the outer side included in the backlight device in Variation 4 of Embodiment 1.

FIG. 19 is a plan view of a backlight device in comparison example 3.

FIG. 20 is a plan view of a backlight device in comparison example 4.

FIG. 21 is a plan view of a backlight device in Variation 5 of Embodiment 1.

FIG. 22 is a plan view of a backlight device in Variation 6 of Embodiment 1.

FIG. 23 is an enlarged view of an optical element on the outer side of the backlight device in Variation 6 of Embodiment 1.

FIG. 24 illustrates the curvature of the perimeter of the optical element on the outer side in Variation 6 of Embodiment 1.

FIG. 25 is a plan view of a backlight device in Variation 7 of Embodiment 1.

FIG. 26 is a plan view of a backlight device in Variation 8 of Embodiment 1.

FIG. 27 illustrates a backlight device and a display panel included in a display device in Embodiment 2.

FIG. 28 illustrates a backlight device and a display panel included in a display device in a variation of Embodiment 2.

FIG. 29 is a side view of a display device in Embodiment 3.

FIG. 30 illustrates the types of angle adjustable lens included in the display device in Embodiment 3.

FIG. 31 is a side view of a display device in Variation 1 of Embodiment 3.

FIG. 32 is a side view of a display device in Variation 2 of Embodiment 3.

FIG. 33 illustrates a portion of an angle adjustable lens in Variation 2 of Embodiment 3.

### DESCRIPTION OF EMBODIMENTS

### (Circumstances Leading to the Present Disclosure)

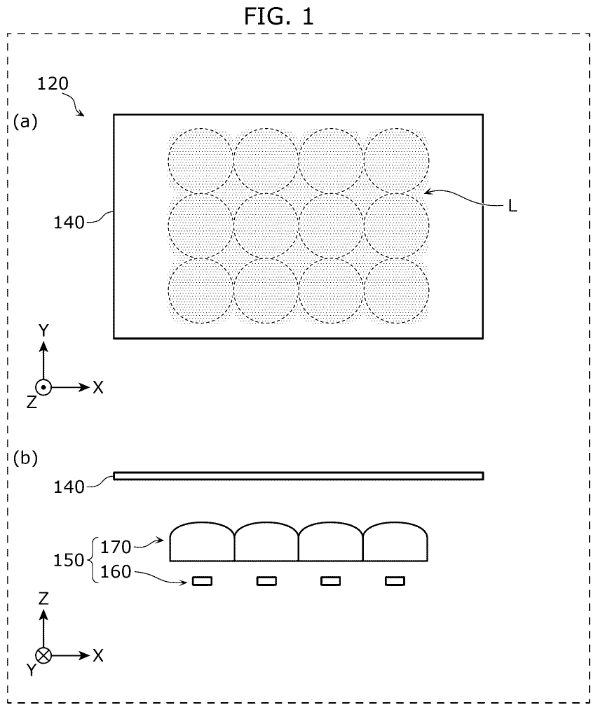

Circumstances leading to the present disclosure are described with reference to FIGS. 1 to 6. In the present disclosure, a display device used in a head-up display apparatus for a vehicle is described. Hereinafter, a head-up display may be referred to as an HUD.

FIG. 1 illustrates backlight device 150 and display panel 140 included in display device 120 in comparison example 1.

(a) in FIG. 1 is a plan view of display device 120, and (b) in FIG. 1 is a side view of display device 120. Hatching for members is omitted in FIG. 1. Likewise, hatching for members is omitted in the subsequent figures. Moreover, in the subsequent figures, a horizontal direction of display panel 140 is defined as an X-axis direction, a vertical direction of display panel 140 is defined as a Y-axis direction, and a thickness direction of display panel 140 is defined as a Z-axis direction.

As illustrated in FIG. 1, display device 120 in comparison example 1 includes backlight device 150 and display panel 140 that outputs an image on the basis of light emitted by backlight device 150. In (a) in FIG. 1, irradiation area L of backlight device 150 is indicated by dot hatching.

To reduce the power consumption of the HUD apparatus and enhance the contrast, display device 120 is required to have a local dimming function. Local dimming involves dividing the display area of display device 120 into areas and controlling the brightness of each of the areas according to the brightness of an image. To perform local dimming, backlight device 150 includes a plurality of light sources 160 arranged in a two-dimensional array and a plurality of lenses 170 having a one-to-one correspondence with the plurality of light sources 160. Display panel 140 is, for example, a liquid crystal panel that transmits light.

The HUD apparatus is an apparatus that displays, on the windshield of a vehicle, a virtual image of an image output by display device 120, with the virtual image being superposed onto a scene in front of the vehicle. Specifically, the HUD apparatus causes, for example, a mirror to reflect an image output by display device 120, to project the image onto the obliquely inclined windshield. Thus, when for instance display device 120 outputs a rectangular image, the image projected on the windshield may appear as a trapezoidal image.

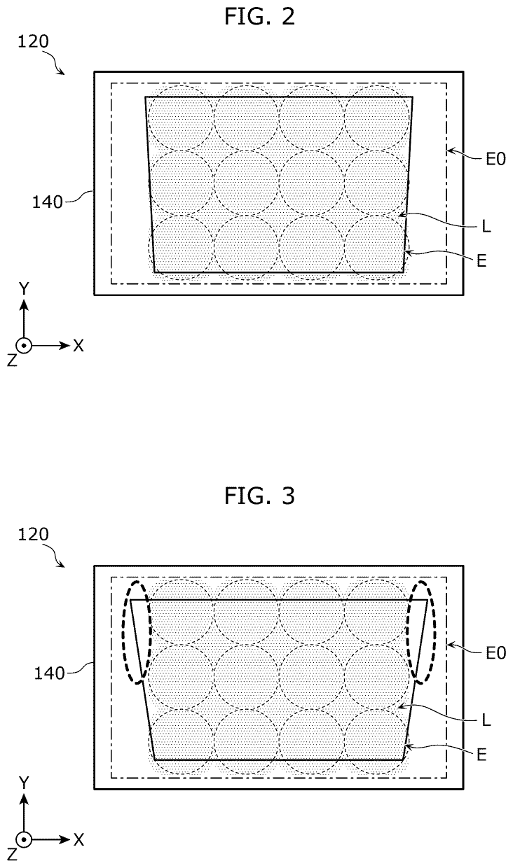

FIG. 2 illustrates an example of display area E of display device 120 included in a first vehicle.

It should be noted that FIG. 2 also illustrates displayable area E0 that is an area where an image of predetermined display quality or higher can be displayed. Since the shape of display area E may differ depending on the type of vehicle, display area E is formed inside displayable area E0. It should be noted that the types of vehicle include variations in types resulting from a model change.

FIG. 2 illustrates an example in which trapezoid correction is performed using display device 120 to avoid the image to be projected onto the windshield having a trapezoidal shape. For instance, display device 120 changes the shape of display area E such that the image output by display device 120 has a trapezoidal shape that appears upside down compared to the shape of the image to be projected onto the windshield (for example, a shape of a top-to-bottom inverted trapezoid). In other words, display device 120 changes the shape of display area E such that the image output by display device 120 has a shape that appears vertically inverted or horizontally flipped compared to the shape of the image to be projected onto the windshield. In the example, display area E approximately corresponds to irradiation area L of backlight device 150, and an image displayed on display area E is properly projected onto the windshield.

Typically, the shape of a windshield and the position at which display device 120 is located differ for each type of vehicle. Thus, it is necessary to change the shape of display area E of display device 120 for each type of vehicle.

FIG. 3 illustrates an example of display area E of display device 120 included in a second vehicle. It should be noted that the type of the second vehicle differs from that of the first vehicle.

Also in FIG. 3, an example is illustrated in which trapezoid correction is performed using display device 120 to avoid an image to be projected onto the windshield having a trapezoidal shape. However, in the example, portions of display area E (areas surrounded by ellipses) extend beyond irradiation area L of backlight device 150. This makes it difficult for light emitted by backlight device 150 to enter the portions of display area E, which makes it difficult to project images at the portions of display area E onto the windshield. Thus, in display device 120 in comparison example 1, the display uniformity of display area E may decrease depending on the type of vehicle.

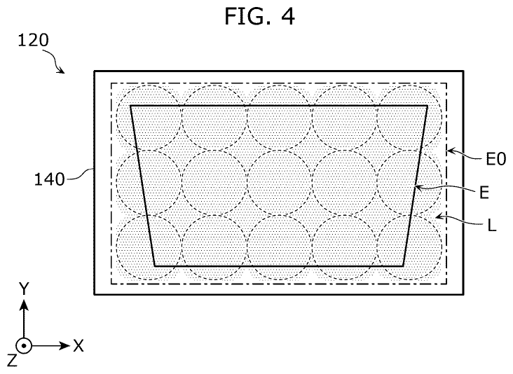

FIG. 4 illustrates an example of display area E of display device 120 in comparison example 2.

FIG. 4 illustrates an example in which the number of light sources 160 and the number of lenses 170 in backlight device 150 are increased to match irradiation area L of backlight device 150 with display area E. However, as an issue, an increase in the number of light sources 160 leads to an increase in heat generation in display device 120. Moreover, as another issue, an increase in the number of light sources 160 and the number of lenses 170 leads to an increase in the number of components and the manufacturing workload.

In view of this, the present disclosure provides display device 20 capable of suppressing the display uniformity of display area E from decreasing, without increasing the number of light sources or the number of lenses.

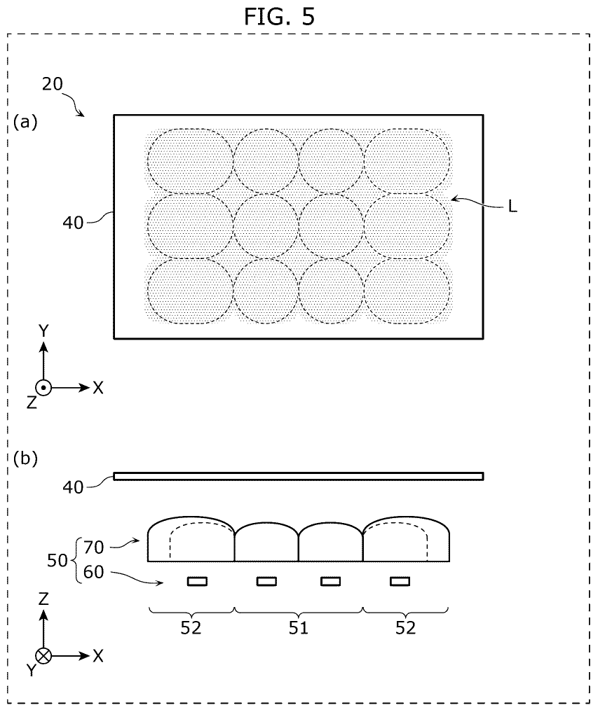

FIG. 5 illustrates backlight device 50 and display panel 40 included in display device 20 in the present disclosure. (a) in FIG. 5 is a plan view of display device 20, and (b) in FIG. 5 is a side view of display device 20.

As illustrated in FIG. 5, display device 20 in the present disclosure includes backlight device 50 and display panel 40 that outputs an image on the basis of light emitted by backlight device 50. Backlight device 50 includes a plurality of light sources 60 arranged in a two-dimensional array and a plurality of optical elements 70 having a one-to-one correspondence with the plurality of light sources 60. Optical element 70 is, for example, a lens or a reflector.

In the present disclosure, the shapes and arrangement of optical elements 70 and light sources 60 located in outer peripheral area 52 that is within an area where the plurality of optical elements 70 and the plurality of light sources 60 are provided differ from the shapes and arrangement of optical elements 70 and light sources 60 located in inner area 51 of backlight device 50, thereby suppressing the light amount at an outer peripheral portion of display area E from decreasing.

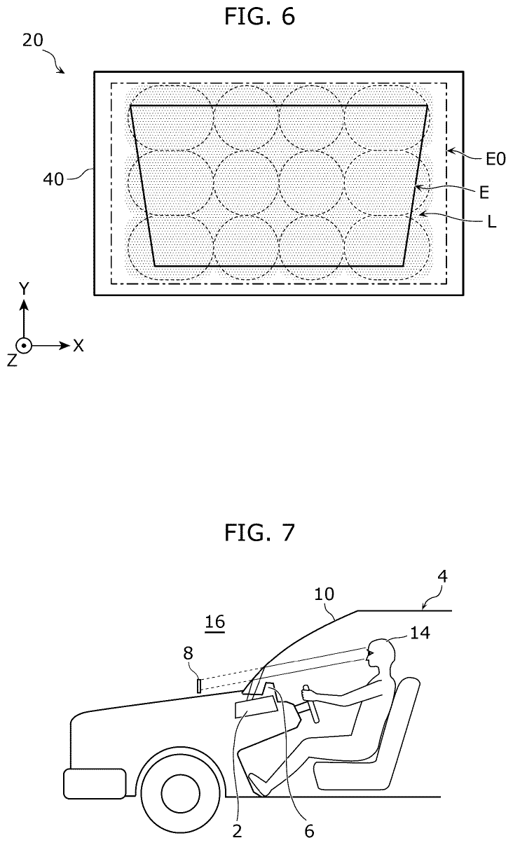

FIG. 6 illustrates an example of display area E of display device 20 in the present disclosure.

FIG. 6 illustrates display area E of display device 20 included in a second vehicle. In FIG. 6, since irradiation area L (area indicated by dot hatching) of backlight device 50 covers display area E, it is possible to suppress the display uniformity of display area E from decreasing. Moreover, since it is possible to suppress the display uniformity of display area E from decreasing, one display device 20 can be employed in HUD apparatuses for more than one type of vehicle.

Hereinafter, embodiments are described in detail with reference to the drawings.

It should be noted that the embodiments described below each indicate a general or specific example. The numerical values, shapes, materials, constituent elements, arrangement and connection of the constituent elements, steps, order of steps, and other details indicated in the embodiments described below are merely examples, and do not intend to limit the present disclosure. Moreover, the constituent elements not recited in the independent claims, which indicate superordinate concepts, among those described in the embodiments below are described as optional constituent elements.

### Embodiment 1

### [Configuration of Head-Up Display Apparatus]

A configuration of a head-up display apparatus according to Embodiment 1 is described with reference to FIGS. 7 to 9.

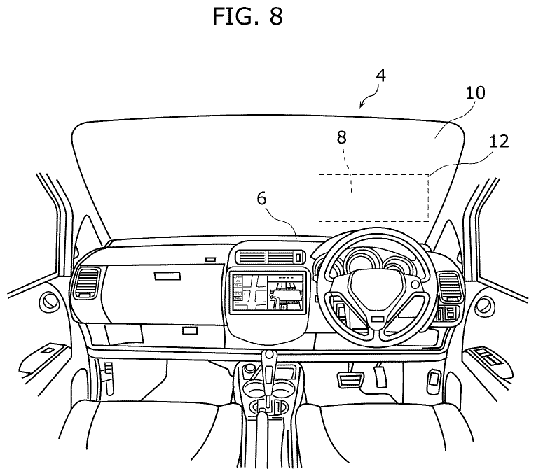

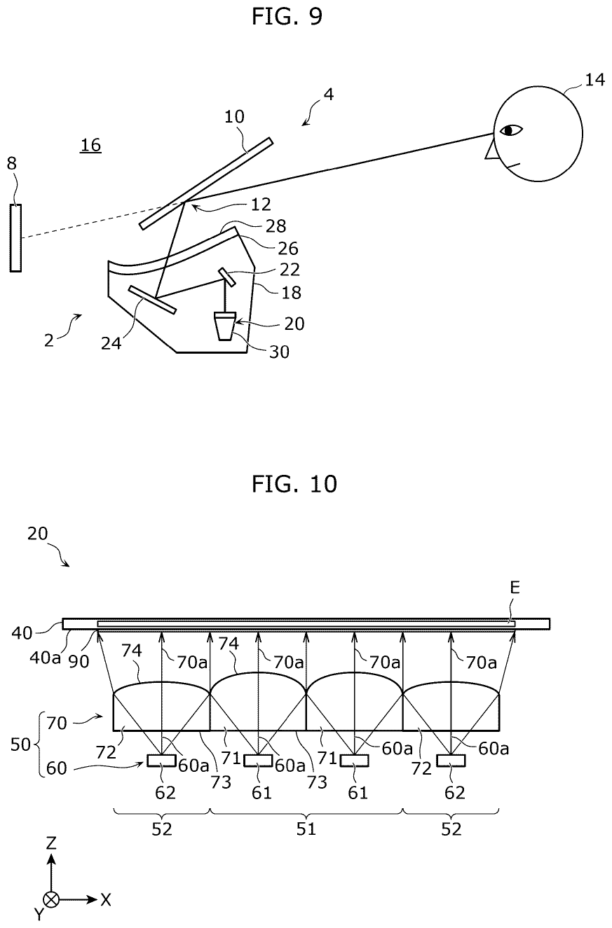

FIG. 7 illustrates vehicle 4 provided with head-up display apparatus 2 according to Embodiment 1. FIG. 8 illustrates area 12 of windshield 10 on which HUD image 8 is to be displayed by head-up display apparatus 2. FIG. 9 illustrates a configuration of head-up display apparatus 2.

As illustrated in FIG. 7, HUD apparatus 2 is located inside dashboard 6 of vehicle 4 such as an automobile.

As illustrated in FIGS. 7 to 9, in HUD apparatus 2, display light for displaying HUD image 8 that is a virtual image is, for example, projected toward area 12 located on the driver's side and the lower side of windshield 10 of vehicle 4. In this way, the display light is reflected off area 12 of windshield 10 toward driver 14. This enables driver 14 to see, at area 12 of windshield 10, HUD image 8, which is a virtual image, superposed on the scene in front of windshield 10. That is, HUD image 8 appears to driver 14 as if it is displayed in space 16 ahead of windshield 10.

As illustrated in FIG. 9, HUD apparatus 2 includes main housing 18, display device 20, first mirror 22, and second mirror 24. It should be noted that HUD apparatus 2 may include a glass plate and a heat sink (illustration is omitted).

Main housing 18 is box-shaped and made of metal such as aluminum. Main housing 18 is located inside dashboard 6 of vehicle 4. Main housing 18 houses display device 20, first mirror 22, and second mirror 24 inside. The top surface of main housing 18 faces windshield 10. Opening 26 is formed in the top surface of main housing 18. Opening 26 is covered with cover member 28 made of, for example, a transparent resin plate.

Display device 20 is, for example, a picture generation unit (PGU), and projects display light for displaying HUD image 8 toward first mirror 22.

First mirror 22 is, for example, a convex mirror, and reflects the display light emitted by display device 20, toward second mirror 24. Second mirror 24 is, for example, a concave mirror, and reflects the display light reflected off first mirror 22 toward area 12 of windshield 10. The display light reflected off second mirror 24 transmits through cover member 28, is reflected off area 12 of windshield 10, and then enters the eyes of driver 14.

It should be noted that in Embodiment 1, an example in which HUD apparatus 2 includes two or more mirrors is provided as a non-limiting example. HUD apparatus 2 may include one mirror.

### [Configuration of Display Device]

A configuration of display device 20 in Embodiment 1 is described with reference to FIGS. 10 to 13.

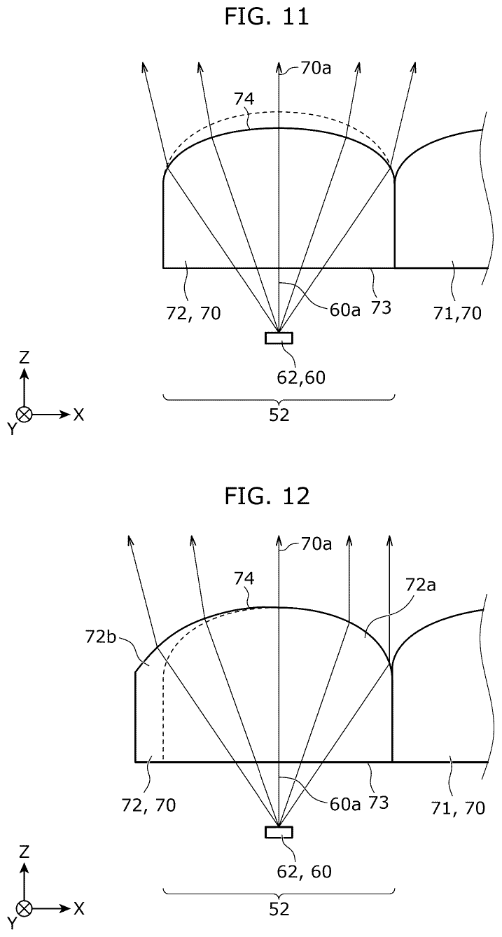

FIG. 10 illustrates backlight device 50 and display panel 40 included in display device 20 in Embodiment 1. FIG. 11 illustrates optical element 72 on the outer side included in backlight device 50.

As illustrated in FIG. 10, display device 20 includes backlight device 50, diffuser plate 90, and display panel 40. Backlight device 50, diffuser plate 90, and display panel 40 are arranged in a Z-axis direction in the order stated, and housed inside case 30 (see FIG. 9).

Backlight device 50 is a device that emits light toward back face 40a of display panel 40. Backlight device 50 includes a plurality of light sources 60 and a plurality of optical elements 70. Backlight device 50 is also referred to as a backlight unit. Diffuser plate 90 is a sheet-like plate for diffusing and homogenizing light. Diffuser plate 90 is provided between backlight device 50 and display panel 40. Diffuser plate 90 may be so disposed that the plate surface of diffuser plate 90 is perpendicular to the Z-axis direction, and may be so disposed that the plate surface of diffuser plate 90 is inclined, rather than being perpendicular to the Z-axis direction. It should be noted that although FIG. 10 illustrates an example in which display device 20 includes diffuser plate 90 as a non-limiting example, display device 20 need not include diffuser plate 90.

Display panel 40 is a panel to output an image on the basis of light emitted by backlight device 50. Display panel 40 is, for example, a liquid crystal panel, and has a rectangular external shape when viewed from an XY plane. Back face 40a of display panel 40 faces diffuser plate 90 and backlight device 50. Display panel 40 may be so disposed that back face 40a is perpendicular to the Z-axis direction, and may be so disposed that back face 40a is inclined, rather than being perpendicular to the Z-axis direction.

Display area E to display an image is formed in display panel 40. In FIG. 10, an end portion of display area E extends beyond optical element 72 on the outer side. Light incident on back face 40a of display panel 40 transmits through and exits display area E of display panel 40. Then, the light is projected onto windshield 10 as display light representing an image displayed on display area E.

As described above, backlight device 50 includes the plurality of light sources 60 and the plurality of optical elements 70.

The plurality of light sources 60 are arranged in a matrix, that is, in a two-dimensional array at regular intervals. Light source 60 is a light-emitting element such as a light-emitting diode (LED). The plurality of light sources 60 each have the same light-emitting area and light-emitting size. The plurality of light sources 60 are formed on or mounted on a board (illustration is omitted).

The plurality of optical elements 70 are provided in a one-to-one correspondence with the plurality of light sources 60. Optical element 70 is so disposed that optical axis 70a of optical element 70 matches optical axis 60a of light source 60. That is, the plurality of optical elements 70 are also arranged in a matrix, that is, in a two-dimensional array at regular intervals. The plurality of optical elements 70 are composite elements of, for example, a lens array, and are made of, for example, a glass material or a resin material. Each of the plurality of optical elements 70 is symmetrical with respect to optical axis 70a of optical element 70. Each optical element 70 has a function of converging and outputting incident light. That is, each optical element 70 has positive power.

In FIG. 10, optical elements 70 and light sources 60 are arranged in an X-axis direction. Likewise, optical elements 70 and light sources 60 are arranged in a Y-axis direction. The plurality of light sources 60 are arranged in a matrix of three or more by three or more, and the plurality of optical elements 70 are arranged in a matrix of three or more by three or more. Moreover, in FIG. 10, a line is drawn between two adjacent optical elements 70 to facilitate understanding. However, in reality, a line (for example, a boundary line) is not formed between two adjacent optical elements 70.

The plurality of optical elements 70 are formed between the plurality of light sources 60 and display panel 40. Light emitted by light source 60 is incident on optical element 70. Optical element 70 converges the incident light and outputs the light toward diffuser plate 90 and display panel 40.

Each of the plurality of optical elements 70 include light incident surface 73 facing light source 60 and light exit surface 74 facing diffuser plate 90 or display panel 40. Each of light incident surfaces 73 of the plurality of optical elements 70 is planar and has the same area. Each of light exit surfaces 74 of the plurality of optical elements 70 is a convex curved surface, and the area of the curved surface of optical element 72 on the outer side differs from that of the curved surface of optical element 71 on the inner side.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Outer peripheral area 52 is an outer peripheral portion when backlight device 50 is viewed from an XY plane. The expression, when viewed from an XY plane means when viewed in a direction along optical axis 70a or when viewed in the Z-axis direction. Outer peripheral area 52 has a frame-like shape. For instance, the frame width of outer peripheral area 52 is the same as the size width of one optical element 70. Optical elements 71 on the inner side are located in inner area 51 located inward from outer peripheral area 52.

FIG. 10 illustrates an example in which four optical elements 70 are arranged in the X-axis direction. Four optical elements 70 include two optical elements 72 on the outer side located in outer peripheral area 52 and two optical elements 71 on the inner side located in inner area 51. As illustrated in FIG. 11, in comparison with optical element 71 on the inner side, optical element 72 on the outer side is short in height, and the curvature of light exit surface 74, which is a convex curved surface, is small. It should be noted that the dashed line shown in FIG. 11 is the outline of optical element 71 on the inner side, which is shown for comparison. A small curvature means a large radius of curvature.

In Embodiment 1, optical element 72 on the outer side located in outer peripheral area 52 and optical element 71 on the inner side located in inner area 51 have different configurations. Here, outer peripheral area 52 and inner area 51 are included in the area where the plurality of optical elements 70 are arranged. In the example, optical element 72 on the outer side is configured to have power different from that of optical element 71 on the inner side. More specifically, optical element 72 on the outer side is configured to have lower power than optical element 71 on the inner side. Low power means low capability of converging light.

By setting the power of optical element 72 on the outer side to a lower power, the angle of divergence of light exiting light exit surface 74 of optical element 72 on the outer side becomes larger. For instance, as illustrated in FIG. 10, optical element 71 on the inner side converges light emitted by light source 61 on the inner side, and outputs the light approximately parallel to optical axis 70a. Meanwhile, optical element 72 on the outer side slightly diffuses light emitted by light source 62 on the outer side, and outputs the light. In this way, by setting the power of optical element 72 on the outer side to lower power, it is possible to expand irradiation area L of backlight device 50, which in turn can suppress the light amount at the outer peripheral portion of display area E from decreasing. As such, it is possible to suppress the display uniformity of display area E from decreasing.

### Variation 1 of Embodiment 1

Display device 20 in Variation 1 of Embodiment 1 is described. In Variation 1, an example in which optical element 72 on the outer side is asymmetrical with respect to optical axis 70a is described.

FIG. 12 illustrates optical element 72 on the outer side included in backlight device 50 in Variation 1. It should be noted that illustration of diffuser plate 90 is omitted in FIG. 12. Likewise, illustration of diffuser plate 90 may be omitted in the subsequent figures.

Display device 20 in Variation 1 includes backlight device 50 and display panel 40. Backlight device 50 includes a plurality of light sources 60 arranged in a two-dimensional array and a plurality of optical elements 70 having a one-to-one correspondence with the plurality of light sources 60. Display panel 40 in Variation 1 has a configuration similar to the configuration described in Embodiment 1.

Each of the plurality of light sources 60 illustrated in FIG. 12 is symmetrical with respect to optical axis 60a of light source 60. Optical element 71 on the inner side among the plurality of optical elements 70 is symmetrical with respect to optical axis 70a of optical element 71 on the inner side. Meanwhile, optical element 72 on the outer side is asymmetrical with respect to optical axis 70a of optical element 72 on the outer side.

Optical element 72 on the outer side includes inner portion 72a and outer portion 72b. Here, inner portion 72a is located closer to optical element 71 on the inner side than optical axis 70a of optical element 72 on the outer side is. Outer portion 72b is located on the opposite side from optical element 71 on the inner side. The power of outer portion 72b differs from that of inner portion 72a. In the example, the power of outer portion 72b is lower than that of inner portion 72a. Moreover, the curvature of light exit surface 74 of outer portion 72b is smaller than that of light exit surface 74 of inner portion 72a. It should be noted that the dashed line shown in FIG. 12 is the outline of optical element 71 on the inner side, which is shown for comparison.

By setting the power of outer portion 72b to lower power, the angle of divergence of light exiting outer portion 72b of optical element 72 on the outer side becomes larger. For instance, as illustrated in FIG. 12, inner portion 72a converges light emitted by light source 62 on the outer side, and outputs the light approximately parallel to optical axis 70a. Meanwhile, outer portion 72b slightly diffuses light emitted by light source 62 on the outer side, and outputs the light. In this way, by setting the power of outer portion 72b to lower power, it is possible to expand irradiation area L of backlight device 50, which in turn can suppress the light amount at an outer peripheral portion of display area E from decreasing. As such, it is possible to suppress the display uniformity of display area E from decreasing.

### Variation 2 of Embodiment 1

Display device 20 in Variation 2 of Embodiment 1 is described. In Variation 2, an example is described in which the distance between the center of optical element 72 on the outer side and the center of optical element 71 on the inner side is greater than a corresponding distance in Embodiment 1.

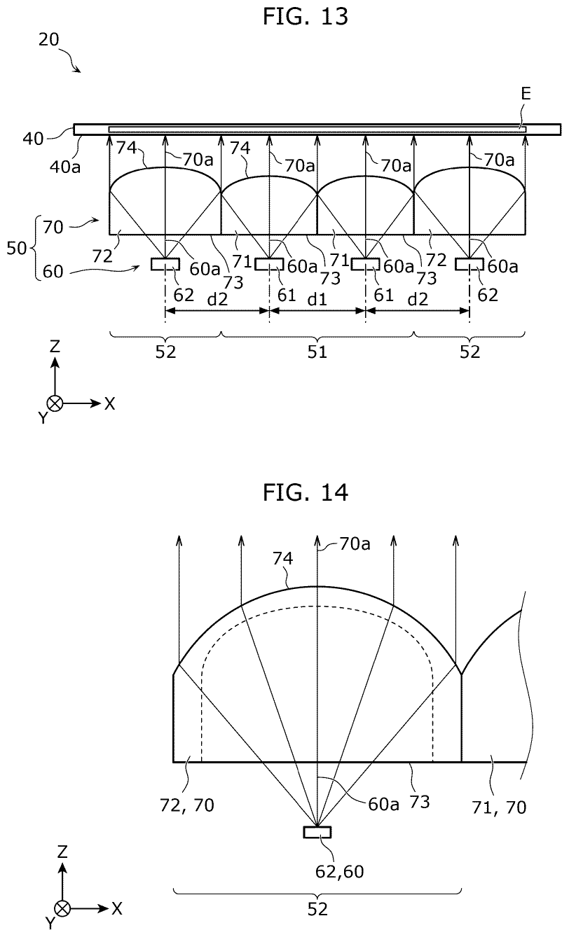

FIG. 13 illustrates backlight device 50 and display panel 40 included in display device 20 in Variation 2 of Embodiment 1. FIG. 14 illustrates light source 62 and optical element 72 on the outer side that are included in backlight device 50.

As illustrated in FIG. 13, display device 20 in Variation 2 includes backlight device 50 and display panel 40. Backlight device 50 includes a plurality of light sources 60 arranged in a two-dimensional array and a plurality of optical elements 70 having a one-to-one correspondence with the plurality of light sources 60. Display panel 40 in Variation 2 has a configuration similar to the configuration described in Embodiment 1. In FIG. 13, optical elements 70 and light sources 60 are arranged in an X-axis direction. Likewise, optical elements 70 and light sources 60 are arranged in a Y-axis direction.

The plurality of light sources 60 are arranged in a matrix, that is, in a two-dimensional array. The plurality of light sources 60 each have the same light-emitting area and light-emitting size. Each of the plurality of light sources 60 is symmetrical with respect to optical axis 60a of light source 60.

The plurality of light sources 60 in Variation 2 include (i) light sources 62 on the outer side located in at least a portion of outer peripheral area 52 that is within an area where the plurality of light sources 60 are arranged and (ii) light sources 61 on the inner side located inward from light sources 62 on the outer side. Distance d2 between optical axis 60a of light source 62 on the outer side and optical axis 60a of light source 61 on the inner side adjacent to light source 62 on the outer side differs from distance d1 between optical axes 60a of two adjacent light sources 61 on the inner side.

The plurality of optical elements 70 in Variation 2 are provided in a one-to-one correspondence with the plurality of light sources 60. In the example, the plurality of optical elements 70 are so arranged that optical axis 70a of optical element 71 on the inner side matches optical axis 60a of light source 61 on the inner side and that optical axis 70a of optical element 72 on the outer side matches optical axis 60a of light source 62 on the outer side. That is, the plurality of optical elements 70 are also arranged in a matrix, that is, in a two-dimensional array. Each of the plurality of optical elements 70 is symmetrical with respect to optical axis 70a of optical element 70. Each optical element 70 has a function of converging and outputting incident light. That is, each optical element 70 has positive power.

Each of the plurality of optical elements 70 includes light incident surface 73 facing light source 60 and light exit surface 74 facing display panel 40. Light incident surface 73 is planar, and light exit surface 74 is a convex curved surface.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Distance d2 between optical axis 70a of optical element 72 on the outer side and optical axis 70a of optical element 71 on the inner side adjacent to optical element 72 on the outer side differs from distance d1 between optical axes 70a of two adjacent optical elements 71 on the inner side.

FIG. 13 illustrates an example in which four optical elements 70 are arranged in the X-axis direction. Four optical elements 70 include two optical elements 72 on the outer side located in outer peripheral area 52 and two optical elements 71 on the inner side located in inner area 51.

Each of light incident surfaces 73 of four optical elements 70 is planar, and the area of the flat surface of optical element 72 on the outer side differs from the area of the flat surface of optical element 71 on the inner side. Each of light exit surfaces 74 of four optical elements 70 is a convex curved surface, and optical elements 72 on the outer side and optical elements 71 on the inner side differ in terms of the height and area of light exit surface 74. That is, the effective size of optical element 72 on the outer side differs from that of optical element 71 on the inner side. Specifically, as illustrated in FIG. 14, light exit surface 74 of optical element 72 on the outer side is positioned at a position higher than the position of light exit surface 74 of optical element 71 on the inner side, and the area of light exit surface 74 of optical element 72 on the outer side is larger than that of light exit surface 74 of optical element 71 on the inner side. That is, the effective size of optical element 72 on the outer side is greater than that of optical element 71 on the inner side. It should be noted that the dashed line shown in FIG. 14 is the outline of optical element 71 on the inner side, which is shown for comparison.

In Variation 2, optical elements 72 and light sources 62 on the outer side located in outer peripheral area 52 have configurations different from those of optical elements 71 and light sources 61 on the inner side located in inner area 51. Here, outer peripheral area 52 and inner area 51 are included in the area where the plurality of optical elements 70 and the plurality of light sources 60 are arranged. Specifically, distance d2 between optical axis 70a of optical element 72 on the outer side and optical axis 70a of optical element 71 on the inner side adjacent to optical element 72 on the outer side is greater than distance d1 between optical axes 70a of two adjacent optical elements 71 on the inner side. Moreover, distance d2 between optical axis 60a of light source 62 on the outer side and optical axis 60a of light source 61 on the inner side adjacent to light source 62 on the outer side is greater than distance d1 between optical axes 60a of two adjacent light sources 61 on the inner side.

By setting distance d2>distance d1 as described above with regard to the distance between optical axes 70a of optical elements 70, the width of light exiting light exit surface 74 of optical element 72 on the outer side becomes larger. For instance, as illustrated in FIG. 13, optical element 71 on the inner side outputs light of a width corresponding to optical element 71 on the inner side. Meanwhile, optical element 72 on the outer side outputs light of a width corresponding to optical element 72 on the outer side having a greater width than optical element 71 on the inner side. In this way, irradiation area L of backlight device 50 can be expanded by increasing the width of light exiting optical element 72 on the outer side. Thus, it is possible to suppress the light amount at an outer peripheral portion of display area E from decreasing. As such, it is possible to suppress the display uniformity of display area E from decreasing.

### Variation 3 of Embodiment 1

Display device 20 in Variation 3 of Embodiment 1 is described. In Variation 3, an example is described in which the light-emitting size of light source 62 on the outer side is greater than that of light source 61 on the inner side.

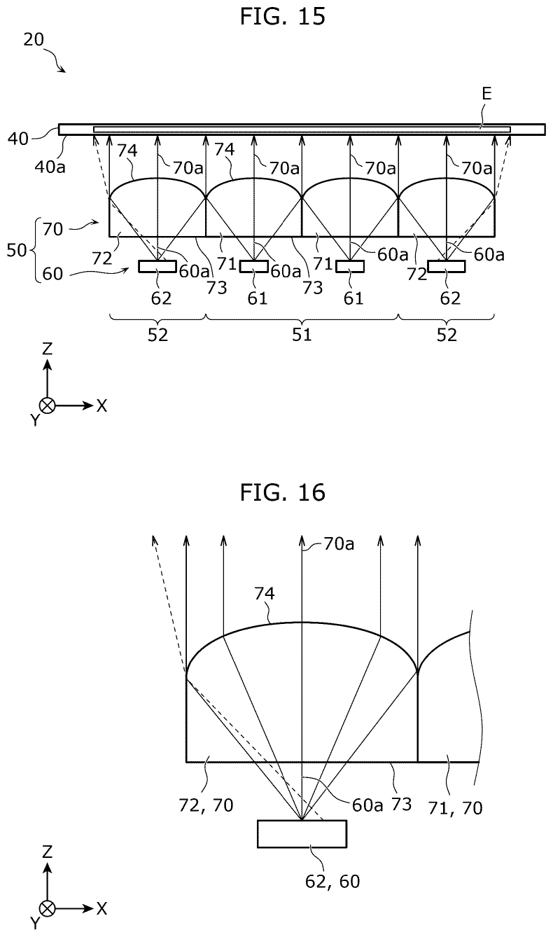

FIG. 15 illustrates backlight device 50 and display panel 40 included in display device 20 in Variation 3 of Embodiment 1. FIG. 16 illustrates light source 62 on the outer side included in backlight device 50.

As illustrated in FIG. 15, display device 20 in Variation 3 includes backlight 50 and display panel 40. Backlight device 50 includes a plurality of light sources 60 arranged in a two-dimensional array and a plurality of optical elements 70 having a one-to-one correspondence with the plurality of light sources 60. A configuration of display panel 40 in Variation 3 is similar to the configuration described in Embodiment 1. In FIG. 15, optical elements 70 and light sources 60 are arranged in an X-axis direction. Likewise, optical elements 70 and light sources 60 are arranged in a Y-axis direction.

The plurality of light sources 60 are arranged in a matrix, that is, in a two-dimensional array at regular intervals. Each of the plurality of light sources 60 is symmetrical with respect to optical axis 60a of light source 60.

The plurality of light sources 60 in Variation 3 include (i) light sources 62 on the outer side located in at least a portion of outer peripheral area 52 that is within an area where the plurality of light sources 60 are arranged and (ii) light sources 61 on the inner side located inward from light sources 62 on the outer side. The light-emitting size of light source 62 on the outer side differs from that of light source 61 on the inner side. In the example, the light-emitting size of light source 62 on the outer side is greater than that of light source 61 on the inner side. A large light-emitting size means that light source 60 has a large light-emitting area.

The plurality of optical elements 70 in Variation 3 are provided in a one-to-one correspondence with the plurality of light sources 60. Optical element 70 is so disposed that optical axis 70a of optical element 70 matches optical axis 60a of light source 60. That is, the plurality of optical elements 70 are also arranged in a matrix, that is, in a two-dimensional array at regular intervals. Each of the plurality of optical elements 70 has the same shape and is symmetrical with respect to optical axis 70a of optical element 70. Each optical element 70 has a function of converging and outputting incident light. That is, each optical element 70 has positive power.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. FIG. 15 illustrates an example in which four optical elements 70 are arranged in the X-axis direction. Four optical elements 70 include two optical elements 72 on the outer side located in outer peripheral area 52 and two optical elements 71 on the inner side located in inner area 51.

In Variation 3, light source 62 on the outer side located in outer peripheral area 52 and light source 61 on the inner side located in inner area 51 have different configurations. Here, outer peripheral area 52 and inner area 51 are included in the area where the plurality of light sources 60 are arranged. Specifically, the light-emitting size of light source 62 on the outer side is greater than that of light source 61 on the inner side.

By increasing the light-emitting size of light source 62 on the outer side, the angle of divergence of light exiting light exit surface 74 of optical element 72 on the outer side becomes larger. For instance, as illustrated in FIG. 15, optical element 71 on the inner side converges light emitted by light source 61 on the inner side, and outputs the light approximately parallel to optical axis 70a. Meanwhile, optical element 72 on the outer side outputs, in an obliquely outward direction, light emitted from an inner end portion of light source 62 on the outer side. In this way, by increasing the light-emitting size of light source 62 on the outer side, it is possible to expand irradiation area L of backlight device 50, which in turn can suppress the light amount at an outer peripheral portion of display area E from decreasing. As such, it is possible to suppress the display uniformity of display area E from decreasing.

It should be noted that display device 20 may change the light-emitting power of light source 60 according to the shape of display area E, in addition to the above configuration of light source 60. For instance, in display device 20, when display area E is trapezoidal (see FIG. 6), the light-emitting power of light sources 62 on the outer side located in both end areas of a bottom base may be set to be greater than the light-emitting power of light sources 61 on the inner side located in inner area 51. Moreover, in display device 20, the light-emitting power of light sources 62 located in both end areas of the bottom base may be set to be greater than the light-emitting power of light sources 62 on the outer side located in both end areas of a top base. That is, in display device 20, if display area E includes an area with a large light amount per unit area and an area with a small light amount per unit area, the light-emitting power of light source 60 in the area with the small light amount may be set to be greater than that of light source 60 in the area with the large light amount.

### Variation 4 of Embodiment 1

Display device 20 in Variation 4 of Embodiment 1 is described. In Variation 4, an example in which optical element 72 on the outer side includes total internal reflection (TIR) part 76 is described.

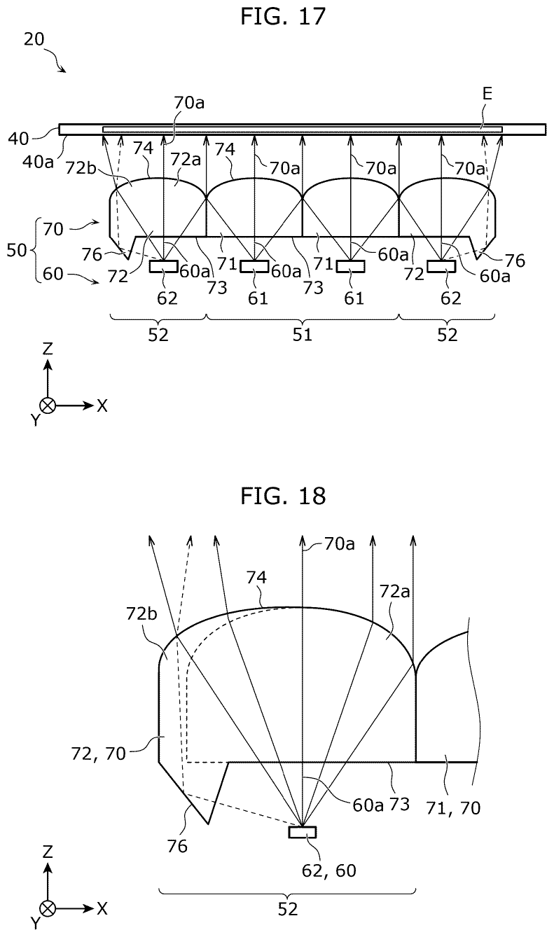

FIG. 17 illustrates backlight device 50 and display panel 40 included in display device 20 in Variation 4 of Embodiment 1. FIG. 18 illustrates optical element 72 on the outer side included in backlight device 50.

As illustrated in FIG. 17, display device 20 in Variation 4 includes backlight 50 and display panel 40. Backlight device 50 includes a plurality of light sources 60 arranged in a two-dimensional array and a plurality of optical elements 70 having a one-to-one correspondence with the plurality of light sources 60. Configurations of display panel 40 and light source 60 in Variation 4 are similar to the configurations described in Embodiment 1.

A configuration of optical element 70 in Variation 4 is also almost the same as the configuration described in Embodiment 1. However, in Variation 4, optical element 72 on the outer side includes TIR part 76. TIR part 76 is a portion for taking in light emitted by light source 62 on the outer side. As illustrated in FIG. 18, TIR part 76 is provided on light incident surface 73 side and at an outermost end portion of optical element 72 on the outer side. It should be noted that the dashed line including a curved line shown in FIG. 18 is the outline of optical element 71 on the inner side, which is shown for comparison.

Thus, in Variation 4, by optical element 72 on the outer side including TIR part 76, it is possible to suppress the light amount at an outer peripheral portion of display area E from decreasing. As such, it is possible to suppress the display uniformity of display area E from decreasing.

### Variations 5 to 8 of Embodiment 1

Backlight devices 50 in Variations 5 to 8 of Embodiment 1 are described. In each of the variations, a shape of optical element 72 on the outer side when backlight device 50 is viewed from an XY plane, is described.

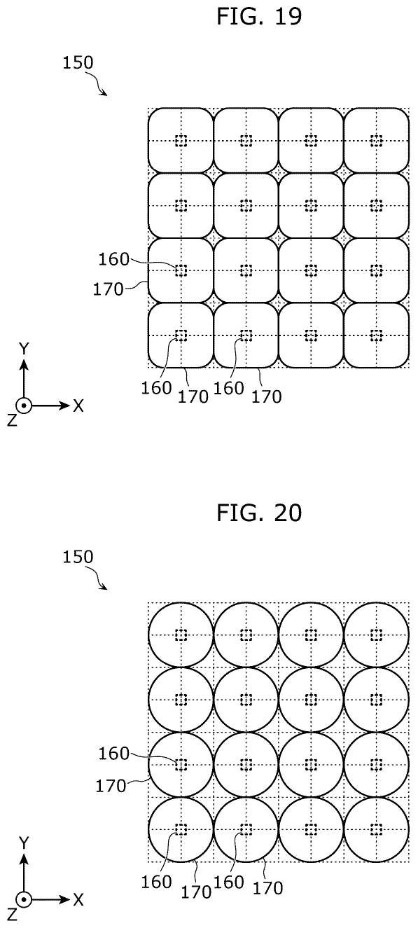

FIG. 19 is a plan view of backlight device 150 in comparison example 3.

FIG. 19 illustrates a plurality of lenses 170 arranged in a two-dimensional array and a plurality of light sources 160 arranged in a two-dimensional array. The plurality of lenses 170 are arranged in a matrix at regular intervals, and the plurality of light sources 160 are arranged in a matrix at regular intervals. When viewed from an XY plane, lens 170 is square and has rounded corners. Each lens 170 has the same shape. Backlight device 150 in comparison example 3 has an issue similar to the issue described in comparison example 1.

FIG. 20 is a plan view of backlight device 150 in comparison example 4.

FIG. 20 illustrates a plurality of lenses 170 arranged in a two-dimensional array and a plurality of light sources 160 arranged in a two-dimensional array. The plurality of lenses 170 are arranged in a matrix at regular intervals, and the plurality of light sources 160 are arranged in a matrix at regular intervals. Lens 170 is circular when viewed from an XY plane. Each lens 170 has the same shape. Backlight device 150 in comparison example 4 has an issue similar to the issue described in comparison example 1.

FIG. 21 is a plan view of backlight device 50 in Variation 5 of Embodiment 1.

FIG. 21 illustrates a plurality of optical elements 70 arranged in a two-dimensional array and a plurality of light sources 60 arranged in a two-dimensional array. The plurality of optical elements 70 are arranged in a matrix at regular intervals, and the plurality of light sources 60 are arranged in a matrix at regular intervals.

Optical element 71 on the inner side among the plurality of optical elements 70 is symmetrical with respect to optical axis 70a of optical element 71 on the inner side. Meanwhile, optical element 72 on the outer side is asymmetrical with respect to optical axis 70a of optical element 72 on the outer side.

For instance, optical element 72 on the outer side includes inner portion 72a and outer portion 72b. Here, inner portion 72a is located closer to optical element 71 on the inner side than optical axis 70a of optical element 72 on the outer side is. Outer portion 72b is located on the opposite side from optical element 71 on the inner side. The power of outer portion 72b is lower than that of inner portion 72a.

In this way, by setting the power of outer portion 72b to lower power, the angle of divergence of light exiting outer portion 72b of optical element 72 on the outer side becomes larger. This can suppress the light amount at an outer peripheral portion of display area E from decreasing. As such, it is possible to suppress the display uniformity of display area E from decreasing.

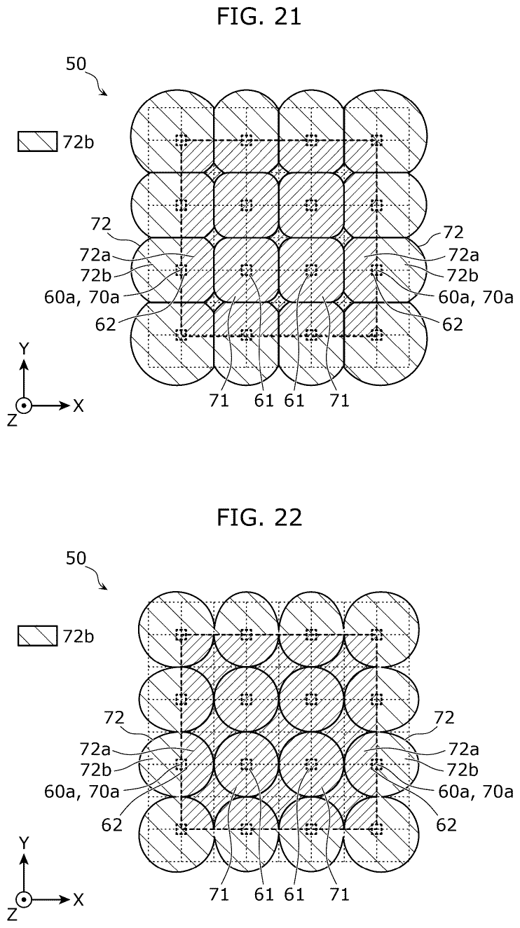

FIG. 22 is a plan view of backlight device 50 in Variation 6 of Embodiment 1.

FIG. 22 illustrates a plurality of optical elements 70 arranged in a two-dimensional array and a plurality of light sources 60 arranged in a two-dimensional array. The plurality of optical elements 70 are arranged in a matrix at regular intervals, and the plurality of light sources 60 are arranged in a matrix at regular intervals.

Optical element 71 on the inner side among the plurality of optical elements 70 is symmetrical with respect to optical axis 70a of optical element 71 on the inner side. Meanwhile, optical element 72 on the outer side is asymmetrical with respect to optical axis 70a of optical element 72 on the outer side.

For instance, optical element 72 on the outer side includes inner portion 72a and outer portion 72b. Here, inner portion 72a is located closer to optical element 71 on the inner side than optical axis 70a of optical element 72 on the outer side is. Outer portion 72b is located on the opposite side from optical element 71 on the inner side. When backlight device 50 is viewed in a direction along optical axis 70a of optical element 72 on the outer side, the curvature of the perimeter of outer portion 72b is smaller than that of the perimeter of inner portion 72a.

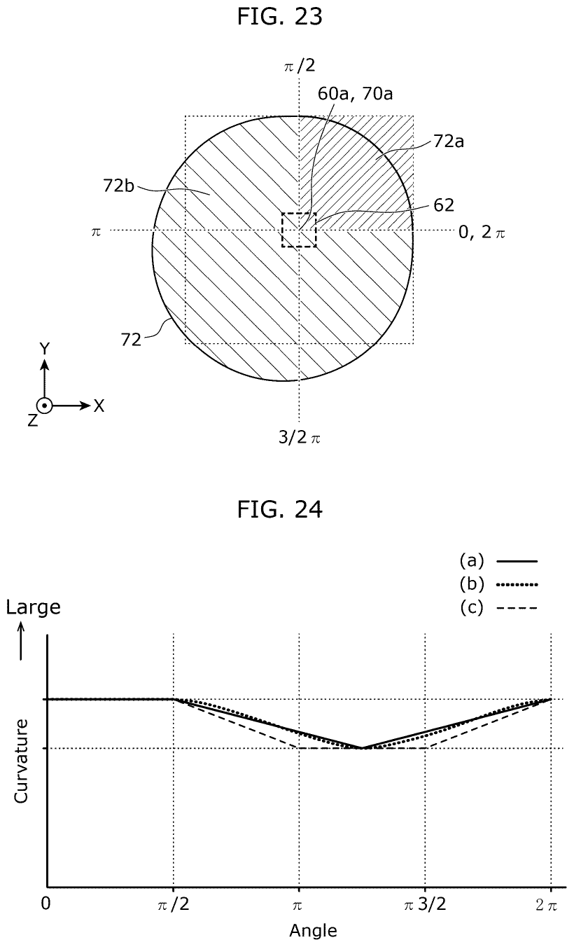

FIG. 23 is an enlarged view of optical element 72 on the outer side of backlight device 50 in Variation 6 of Embodiment 1. FIG. 24 illustrates the curvature of the perimeter of optical element 72 on the outer side in Variation 6 of Embodiment 1.

FIG. 24 illustrates a curvature of optical element 72 on the outer side at angles from 0 to n/2 and a curvature of optical element 72 on the outer side at angles from n/2 to 2n. In an angle range of 0 to n/2 corresponding to inner portion 72a, the curvature is constant. In an angle range of n/2 to 2n corresponding to outer portion 72b, the curvature is smaller than that in the angle range of 0 to n/2, and the curvature varies. It should be noted that an angle is an angle centered on optical axis 70a of optical element 72 on the outer side.

(a) in FIG. 24 illustrates an example in which the curvature decreases and then increases to the original curvature in proportion to the variation in angle. (b) in FIG. 24 illustrates an example in which the curvature varies according to a predetermined function. (c) in FIG. 24 illustrates an example in which the curvature does not vary in a partial angle range of n to 3n/2, and the curvature varies at angles from n/2 to n and angles from 3n/2 to 2n.

In the above examples, the power of outer portion 72b is lower than that of inner portion 72a. By setting the power of outer portion 72b to lower power, the angle of divergence of light exiting outer portion 72b of optical element 72 on the outer side becomes larger. This can suppress the light amount at an outer peripheral portion of display area E from decreasing. As such, it is possible to suppress the display uniformity of display area E from decreasing.

It should be noted that an example in which the curvature of optical element 72 on the outer side gradually varies in an angle range of n/2 to 2n is described above as a non-limiting example. The curvature of optical element 72 on the outer side may vary in a range narrower than an angle range of n/2 to 2n. That is, the curvature of optical element 72 on the outer side may vary within a part of an angle range of n/2 to 2n. Moreover, in the above, an example in which the curvature varies in an angle range of n/2 to 2n is described as a non-limiting example. For instance, a parameter changed in an angle range of n/2 to 2n may be another coefficient that defines the curved surface.

FIG. 25 is a plan view of backlight device 50 in Variation 7 of Embodiment 1.

FIG. 25 illustrates a plurality of optical elements 70 arranged in a two-dimensional array and a plurality of light sources 60 arranged in a two-dimensional array. The plurality of optical elements 70 are arranged in a matrix, and the plurality of light sources 60 are arranged in a matrix.

The plurality of light sources 60 include (i) light sources 62 on the outer side located in at least a portion of outer peripheral area 52 that is within an area where the plurality of light sources 60 are arranged and (ii) light sources 61 on the inner side located inward from light sources 62 on the outer side. Distance d2 between optical axis 60a of light source 62 on the outer side and optical axis 60a of light source 61 on the inner side adjacent to light source 62 on the outer side is greater than distance d1 between optical axes 60a of two adjacent light sources 61 on the inner side.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Distance d2 between optical axis 70a of optical element 72 on the outer side and optical axis 70a of optical element 71 on the inner side adjacent to optical element 72 on the outer side is greater than distance d1 between optical axes 70a of two adjacent optical elements 71 on the inner side.

Each of light exit surfaces 74 of four optical elements 70 is a convex curved surface, and the area of the curved surface of optical element 72 on the outer side differs from that of the curved surface of optical element 71 on the inner side. In the example, the effective size of optical element 72 on the outer side is greater than that of optical element 71 on the inner side.

By setting distance d2>distance d1 as described above with regard to the distance between optical axes 70a of optical elements 70, the width of light exiting light exit surface 74 of optical element 72 on the outer side becomes larger. In this way, irradiation area L of backlight device 50 can be expanded by increasing the width of light exiting optical element 72 on the outer side. Thus, it is possible to suppress the light amount at an outer peripheral portion of display area E from decreasing. As such, it is possible to suppress the display uniformity of display area E from decreasing.

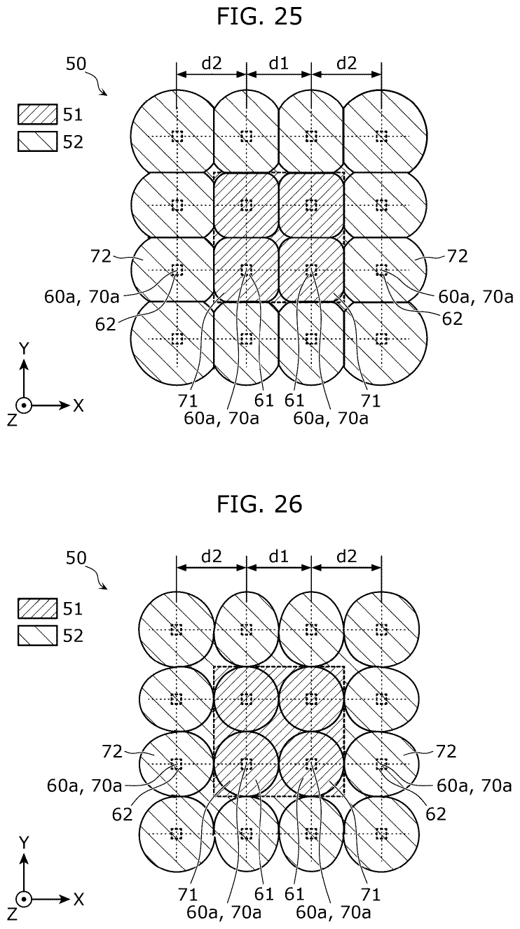

FIG. 26 is a plan view of backlight device 50 in Variation 8 of Embodiment 1.

FIG. 26 illustrates a plurality of optical elements 70 arranged in a two-dimensional array and a plurality of light sources 60 arranged in a two-dimensional array. The plurality of optical elements 70 are arranged in a matrix, and the plurality of light sources 60 are arranged in a matrix.

The plurality of light sources 60 include (i) light sources 62 on the outer side located in at least a portion of outer peripheral area 52 that is within an area where the plurality of light sources 60 are arranged and (ii) light sources 61 on the inner side located inward from light sources 62 on the outer side. Distance d2 between optical axis 60a of light source 62 on the outer side and optical axis 60a of light source 61 on the inner side adjacent to light source 62 on the outer side is greater than distance d1 between optical axes 60a of two adjacent light sources 61 on the inner side.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Distance d2 between optical axis 70a of optical element 72 on the outer side and optical axis 70a of optical element 71 on the inner side adjacent to optical element 72 on the outer side is greater than distance d1 between optical axes 70a of two adjacent optical elements 71 on the inner side.

Each of light exit surfaces 74 of four optical elements 70 is a convex curved surface, and the area of the curved surface of optical element 72 on the outer side differs from that of the curved surface of optical element 71 on the inner side. In the example, the effective size of optical element 72 on the outer side is greater than that of optical element 71 on the inner side. By setting distance d2>distance d1 as described above with regard to the distance between optical axes 70a of optical elements 70, the width of light exiting light exit surface 74 of optical element 72 on the outer side becomes larger. In this way, irradiation area L of backlight device 50 can be expanded by increasing the width of light exiting optical element 72 on the outer side. Thus, it is possible to suppress the light amount at an outer peripheral portion of display area E from decreasing. As such, it is possible to suppress the display uniformity of display area E from decreasing.

### Embodiment 2

### [Configuration of Display Device]

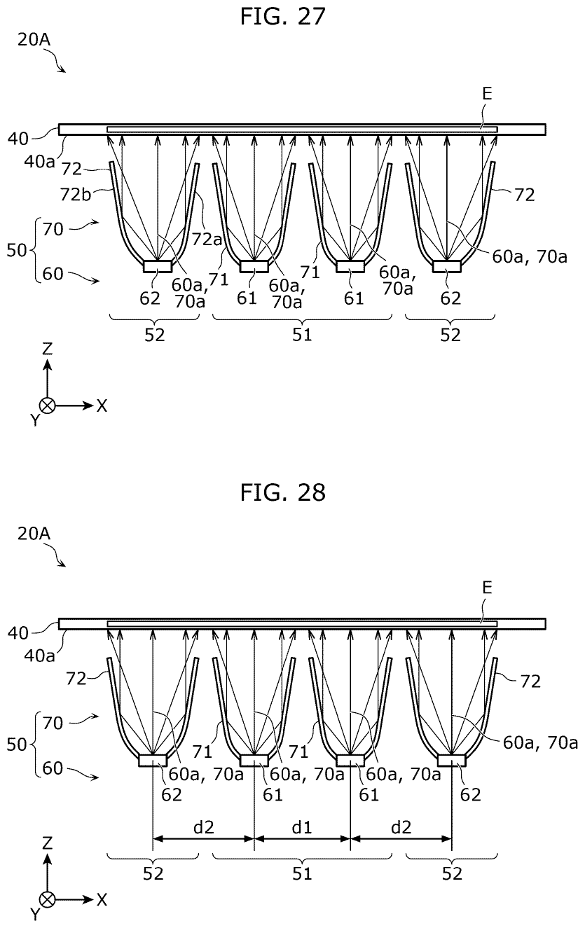

A configuration of display device 20A in Embodiment 2 is described with reference to FIG. 27.

FIG. 27 illustrates backlight device 50 and display panel 40 included in display device 20A in Embodiment 2.

As illustrated in FIG. 27, display device 20A includes backlight device 50, diffuser plate 90, and display panel 40. Backlight device 50, diffuser plate 90, and display panel 40 are arranged in a Z-axis direction in the order stated, and housed inside case 30 (see FIG. 9). It should be noted that illustration of diffuser plate 90 is omitted in FIG. 27. A configuration of display panel 40 is similar to the configuration described in Embodiment 1.

Backlight device 50 is a device that emits light toward back face 40a of display panel 40. Backlight device 50 includes a plurality of light sources 60 and a plurality of optical elements 70.

The plurality of light sources 60 are arranged in a matrix, that is, in a two-dimensional array at regular intervals. Light source 60 is, for example, a light-emitting element such as an LED. The plurality of light sources 60 each have the same light-emitting area and light-emitting size. Each of the plurality of light sources 60 is symmetrical with respect to optical axis 60a of light source 60. The plurality of light sources 60 are formed on or mounted on a board (illustration is omitted).

The plurality of optical elements 70 are provided in a one-to-one correspondence with the plurality of light sources 60. Optical element 70 is so disposed that optical axis 70a of optical element 70 matches optical axis 60a of light source 60. That is, the plurality of optical elements 70 are also arranged in a matrix, that is, in a two-dimensional array at regular intervals. The plurality of optical elements 70 are composite elements of, for example, a reflector array, and are made of, for example, a metal member including a mirror surface. Each of the plurality of optical elements 70 is symmetrical with respect to optical axis 70a of optical element 70. Each optical element 70 has a function of converging and outputting incident light. That is, each optical element 70 has positive power.

In FIG. 27, optical elements 70 and light sources 60 are arranged in an X-axis direction. Likewise, optical elements 70 and light sources 60 are arranged in a Y-axis direction.

The plurality of optical elements 70 are disposed between the plurality of light sources 60 and display panel 40. Light emitted by light source 60 is incident on optical element 70. Optical element 70 reflects and converges the incident light, and then outputs the light toward diffuser plate 90 and display panel 40.

Optical element 70 is U-shaped or V-shaped in cross section, and includes a side surface, an opening, and a bottom surface. A through hole is formed in the bottom surface, and light source 60 is disposed at the through hole.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Outer peripheral area 52 is an outer peripheral portion when backlight device 50 is viewed from an XY plane. Outer peripheral area 52 has a frame-like shape. For instance, the frame width of outer peripheral area 52 is the same as the size width of one optical element 70. Optical elements 71 on the inner side are located in inner area 51 located inward from outer peripheral area 52.

FIG. 27 illustrates an example in which four optical elements 70 are arranged in the X-axis direction. Four optical elements 70 include two optical elements 72 on the outer side located in outer peripheral area 52 and two optical elements 71 on the inner side located in inner area 51.

Optical element 72 on the outer side includes inner portion 72a and outer portion 72b. Here, inner portion 72a is located closer to optical element 71 on the inner side than optical axis 70a of optical element 72 on the outer side is. Outer portion 72b is located on the opposite side from optical element 71 on the inner side. The power of outer portion 72b differs from that of inner portion 72a. In the example, the power of outer portion 72b is lower than that of inner portion 72a. Low power means low capability of converging light. Specifically, the opening angle of the side surface of outer portion 72b is greater than that of the side surface of inner portion 72a. The opening angle of the side surface is the inclination angle of optical element 72 on the outer side relative to optical axis 70a.

By setting the power of outer portion 72b to lower power, the angle of divergence of light exiting outer portion 72b of optical element 72 on the outer side becomes larger. For instance, as illustrated in FIG. 27, inner portion 72a converges light emitted by light source 62 on the outer side, and outputs the light approximately parallel to optical axis 70a. Meanwhile, outer portion 72b slightly diffuses light emitted by light source 62 on the outer side, and outputs the light. In this way, by setting the power of outer portion 72b to lower power, it is possible to expand irradiation area L of backlight device 50, which in turn can suppress the light amount at an outer peripheral portion of display area E from decreasing. As such, it is possible to suppress the display uniformity of display area E from decreasing.

### Variation of Embodiment 2

Display device 20A in a variation of Embodiment 2 is described. In the variation, an example is described in which the distance between the center of optical element 72 on the outer side and the center of optical element 71 on the inner side is greater than a corresponding distance in Embodiment 2.

FIG. 28 illustrates backlight device 50 and display panel 40 included in display device 20A in the variation of Embodiment 2.

As illustrated in FIG. 28, display device 20A in the variation includes backlight device 50 and display panel 40. Backlight device 50 includes a plurality of light sources 60 arranged in a two-dimensional array and a plurality of optical elements 70 having a one-to-one correspondence with the plurality of light sources 60. A configuration of display panel 40 in the variation is similar to the configuration described in Embodiment 2. In FIG. 28, optical elements 70 and light sources 60 are arranged in an X-axis direction. Likewise, optical elements 70 and light sources 60 are arranged in a Y-axis direction.

The plurality of light sources 60 are arranged in a matrix, that is, in a two-dimensional array. The plurality of light sources 60 each have the same light-emitting area and light-emitting size. Each of the plurality of light sources 60 is symmetrical with respect to optical axis 60a of light source 60.

The plurality of light sources 60 in the variation include (i) light sources 62 on the outer side located in at least a portion of outer peripheral area 52 that is within an area where the plurality of light sources 60 are arranged and (ii) light sources 61 on the inner side located inward from light sources 62 on the outer side. Distance d2 between optical axis 60a of light source 62 on the outer side and optical axis 60a of light source 61 on the inner side adjacent to light source 62 on the outer side differs from distance d1 between optical axes 60a of two adjacent light sources 61 on the inner side.

The plurality of optical elements 70 in the variation are provided in a one-to-one correspondence with the plurality of light sources 60. In the example, the plurality of optical elements 70 are so arranged that optical axis 70a of optical element 71 on the inner side matches optical axis 60a of light source 61 on the inner side and that optical axis 70a of optical element 72 on the outer side matches optical axis 60a of light source 62 on the outer side. That is, the plurality of optical elements 70 are also arranged in a matrix, that is, in a two-dimensional array. Each of the plurality of optical elements 70 is symmetrical with respect to optical axis 70a of optical element 70. Each optical element 70 has a function of converging and outputting incident light. That is, each optical element 70 has positive power.

Optical element 70 is U-shaped or V-shaped in cross section, and includes a side surface, an opening, and a bottom surface. A through hole is formed in the bottom surface, and light source 60 is disposed at the through hole.

The plurality of optical elements 70 include (i) optical elements 72 on the outer side located in at least a portion of outer peripheral area 52 that is within an area where the plurality of optical elements 70 are arranged and (ii) optical elements 71 on the inner side located inward from optical elements 72 on the outer side. Distance d2 between optical axis 70a of optical element 72 on the outer side and optical axis 70a of optical element 71 on the inner side adjacent to optical element 72 on the outer side differs from distance d1 between optical axes 70a of two adjacent optical elements 71 on the inner side.

FIG. 28 illustrates an example in which four optical elements 70 are arranged in the X-axis direction is described. Four optical elements 70 include two optical elements 72 on the outer side located in outer peripheral area 52 and two optical elements 71 on the inner side located in inner area 51.

The power of optical element 72 on the outer side differs from that of optical element 71 on the inner side. In the example, the power of optical element 72 on the outer side lower than that of optical element 71 on the inner side. Low power means low capability of converging light. Specifically, the opening angle of the side surface of optical element 72 on the outer side is greater than that of the side surface of optical element 71 on the inner side.

In the variation, optical elements 72 and light source 62 on the outer side located in outer peripheral area 52 have configurations different from those of optical elements 71 and light source 61 on the inner side located in inner area 51. Here, outer peripheral area 52 and inner area 51 are included in the area where the plurality of optical elements 70 and the plurality of light sources 60 are arranged. Specifically, distance d2 between optical axis 70a of optical element 72 on the outer side and optical axis 70a of optical element 71 on the inner side adjacent to optical element 72 on the outer side is greater than distance d1 between optical axes 70a of two adjacent optical elements 71 on the inner side. Moreover, distance d2 between optical axis 60a of light source 62 on the outer side and optical axis 60a of light source 61 on the inner side adjacent to light source 62 on the outer side is greater than distance d1 between optical axes 60a of two adjacent light sources 61 on the inner side.

By setting distance d2>distance d1 as described above with regard to the distance between optical axes 70a of optical elements 70, the width of light exiting optical element 72 on the outer side becomes larger. For instance, as illustrated in FIG. 28, optical element 71 on the inner side outputs light of a width corresponding to optical element 71 on the inner side. Meanwhile, optical element 72 on the outer side outputs light of a width corresponding to optical element 72 on the outer side having a greater width than optical element 71 on the inner side. In this way, irradiation area L of backlight device 50 can be expanded by increasing the width of light exiting optical element 72 on the outer side. Thus, it is possible to suppress the light amount at an outer peripheral portion of display area E from decreasing. As such, it is possible to suppress the display uniformity of display area E from decreasing.

### Embodiment 3

### [Configuration of Display Device]

Display device 20B in Embodiment 3 is described. In Embodiment 3, an example in which angle adjustable lens 80 is provided between backlight device 50 and display panel 40 is described.

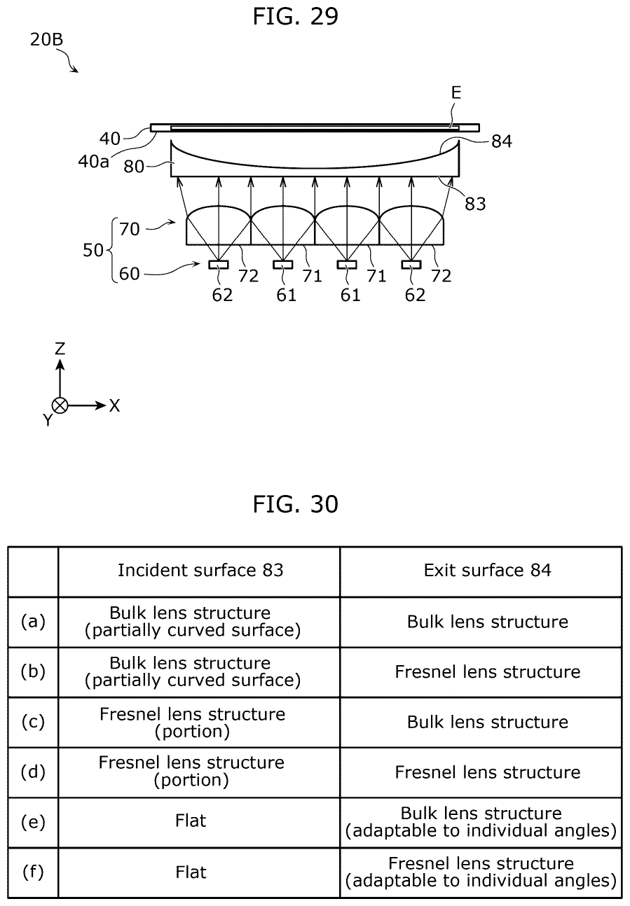

FIG. 29 is a side view of display device 20B in Embodiment 3.

Display device 20B in Embodiment 3 includes backlight device 50, angle adjustable lens 80, diffuser plate 90, and display panel 40. It should be noted that illustration of diffuser plate 90 is omitted in FIG. 29. Configurations of backlight device 50 and display device 20B are similar to the configurations described in Embodiment 1.

Angle adjustable lens 80 is disposed between backlight device 50 and display panel 40 (or diffuser plate 90). Angle adjustable lens 80 is, for example, a field lens. Angle adjustable lens 80 in the example includes flat incident surface 83 and exit surface 84 whose outer peripheral portion is a concave curved surface. Among light rays emitted by backlight device 50, a ray from optical element 72 on the outer side is output obliquely outward. At this time, angle adjustable lens 80 adjusts the angle of incident light. Angle adjustable lens 80 in Embodiment 3 changes the angle of light emitted by backlight device 50 according to the angle of the light, and outputs, toward display panel 40, the light whose angle has been changed. As such, it is possible to suppress the display uniformity of display area E from decreasing.

In the above, an example in which incident surface 83 is flat, and the outer peripheral portion of exit surface 84 is concave curved surface is described. However, the structures of the surfaces are not limited to the above structures.

FIG. 30 illustrates types of angle adjustable lens 80 included in display device 20B in Embodiment 3.

As illustrated in (a) in FIG. 30, incident surface 83 may have a bulk lens structure (partially curved surface), and exit surface 84 may have a bulk lens structure. As illustrated in (b) in FIG. 30, incident surface 83 may have a bulk lens structure (partially curved surface), and exit surface 84 may have a Fresnel lens structure. As illustrated in (c) in FIG. 30, a portion of incident surface 83 may have a Fresnel lens structure, and exit surface 84 may have a bulk lens structure. As illustrated in (d) in FIG. 30, a portion of incident surface 83 may have a Fresnel lens structure, and exit surface 84 may have a Fresnel lens structure. As illustrated in (e) in FIG. 30, incident surface 83 may be flat, and exit surface 84 may have a bulk lens structure adaptable to individual angles. As illustrated in (f) in FIG. 30, incident surface 83 may be flat, and exit surface 84 may have a Fresnel lens structure adaptable to individual angles. The above structures also have effects similar to those of angle adjustable lens 80 illustrated in FIG. 29.

FIG. 30 illustrates typical examples of combinations of incident surface 83 and exit surface 84 of angle adjustable lens 80. However, combinations of incident surface 83 and exit surface 84 other than the above typical examples may be employed.

### Variation 1 of Embodiment 3

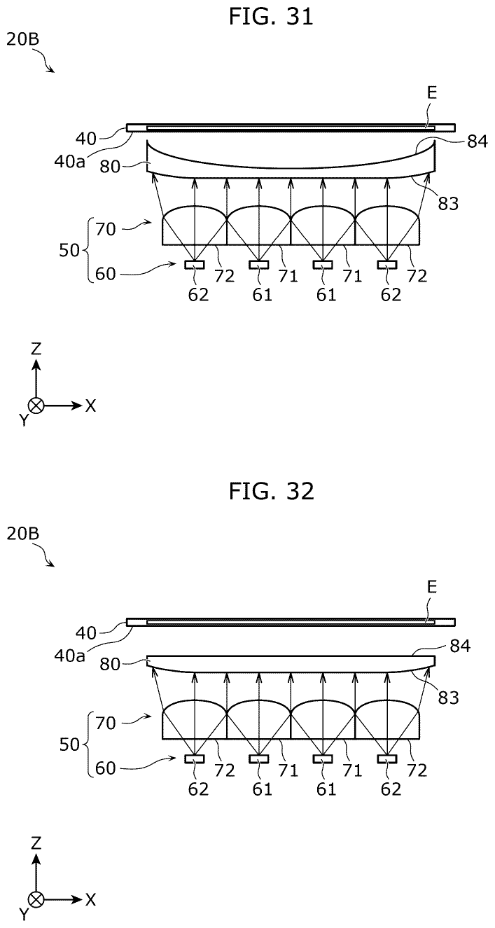

FIG. 31 is a side view of display device 20B in Variation 1 of Embodiment 3.

Display device 20B in Variation 1 includes backlight device 50, angle adjustable lens 80, diffuser plate 90, and display panel 40. Configurations of backlight device 50 and display device 20B are similar to the configurations described in Embodiment 1.

Angle adjustable lens 80 is disposed between backlight device 50 and display panel 40 (or diffuser plate 90). Angle adjustable lens 80 is, for example, a field lens. In angle adjustable lens 80 in the example, an outer peripheral portion of incident surface 83 is a convex curved surface, and an outer peripheral portion of exit surface 84 is a concave curved surface. Among light rays emitted by backlight device 50, a ray from optical element 72 on the outer side is output obliquely outward. At this time, angle adjustable lens 80 adjusts the angle of incident light. Angle adjustable lens 80 in Variation 1 changes the angle of light emitted by backlight device 50 according to the angle of the light, and outputs, toward display panel 40, the light whose angle has been changed. As such, it is possible to suppress the display uniformity of display area E from decreasing.

### Variation 2 of Embodiment 3

FIG. 32 is a side view of display device 20B in Variation 2 of Embodiment 3.

Display device 20B in Variation 2 includes backlight device 50, angle adjustable lens 80, diffuser plate 90, and display panel 40. Configurations of backlight device 50 and display device 20B are similar to the configurations described in Embodiment 1.

Angle adjustable lens 80 is disposed between backlight device 50 and display panel 40 (or diffuser plate 90). Angle adjustable lens 80 is, for example, a field lens. In angle adjustable lens 80 in the example, an outer peripheral portion of incident surface 83 is a convex curved surface, and exit surface 84 has a Fresnel lens structure. Among light rays emitted by backlight device 50, a ray from optical element 72 on the outer side is output obliquely outward. At this time, angle adjustable lens 80 adjusts the angle of incident light. Angle adjustable lens 80 in Variation 2 changes the angle of light emitted by backlight device 50 according to the angle of the light, and outputs, toward display panel 40, the light whose angle has been changed. As such, it is possible to suppress the display uniformity of display area E from decreasing.

It should be noted that the Fresnel lens structure may be configured as below.

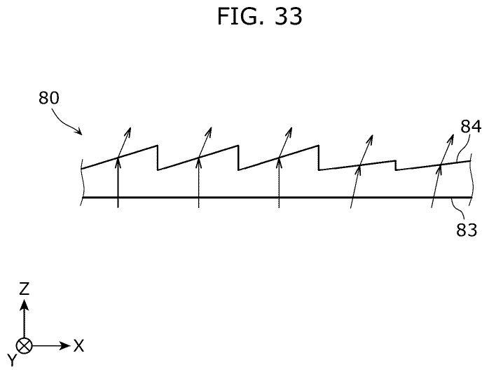

FIG. 33 illustrates a portion of angle adjustable lens 80 in Variation 2 of Embodiment 3.

For instance, when incident surface 83 is flat, angle adjustable lens 80 may be so configured as to change the shape of the Fresnel lens structure of exit surface 84 for each portion according to the angle of incident light. The structure also has effects similar to those of angle adjustable lens 80 illustrated in FIG. 32.

### (Summary of Embodiments)

Display devices (for example, 20, 20A, 20B) according to aspects of the present disclosure are exemplified.

A display device in Example 1 includes: backlight device 50 including a plurality of light sources 60 arranged in a two-dimensional array and a plurality of optical elements 70 having a one-to-one correspondence with the plurality of light sources 60; and display panel 40 that outputs an image on the basis of light emitted by backlight device 50. Each of the plurality of optical elements 70 has positive power. The plurality of optical elements 70 include (i) optical element 72 on the outer side located in at least a portion of outer peripheral area 52 that is within an area where the plurality of optical elements 70 are arranged and (ii) optical element 71 on the inner side located inward from optical element 72 on the outer side. The power of optical element 72 on the outer side differs from the power of optical element 71 on the inner side.

Thus, by optical element 72 on the outer side and optical element 71 on the inner side having different powers, it is possible to adjust irradiation area L of backlight device 50 and the light amount of display area E of the display device. As such, it is possible to suppress the display uniformity of display area E from decreasing. Moreover, since it is possible to suppress the display uniformity of display area E from decreasing, one display device can be employed in more than one type of vehicle, for example.

A display device in Example 2 is the display device according to Example 1, in which the power of optical element 72 on the outer side may be lower than the power of optical element 71 on the inner side.

In this way, by setting the power of optical element 72 on the outer side to lower power, it is possible to expand irradiation area L of backlight device 50, which in turn can suppress the light amount at an outer peripheral portion of display area E from decreasing. As such, it is possible to suppress the display uniformity of display area E from decreasing.

A display device in Example 3 includes: backlight device 50 including a plurality of light sources 60 arranged in a two-dimensional array and a plurality of optical elements 70 having a one-to-one correspondence with the plurality of light sources 60; and display panel 40 that outputs an image on the basis of light emitted by backlight device 50. Each of the plurality of optical elements 70 has positive power. The plurality of optical elements 70 include (i) optical element 72 on the outer side located in at least a portion of outer peripheral area 52 that is within an area where the plurality of optical elements 70 are arranged and (ii) optical element 71 on the inner side located inward from optical element 72 on the outer side. Distance d2 between optical axis 70a of optical element 72 on the outer side and optical axis 70a of optical element 71 on the inner side adjacent to optical element 72 on the outer side differs from distance d1 between optical axes 70a of two adjacent optical elements 71 on the inner side.

By setting distance d2≠distance d1 as described above with regard to the distance between optical axes 70a of optical elements 70, it is possible to adjust the width of light exiting optical element 72 on the outer side. Thus, it is possible to adjust irradiation area L of backlight device 50 and the light amount of display area E of the display device. As such, it is possible to suppress the display uniformity of display area E from decreasing.

A display device in Example 4 is the display device according to Example 3, in which distance d2 between optical axis 70a of optical element 72 on the outer side and optical axis 70a of optical element 71 on the inner side adjacent to optical element 72 on the outer side may be greater than distance d1 between optical axes 70a of two adjacent optical elements 71 on the inner side.

By setting distance d2>distance d1 as described above with regard to the distance between optical axes 70a of optical elements 70, the width of light exiting light exit surface 74 of optical element 72 on the outer side becomes larger. Thus, it is possible to expand irradiation area L of backlight device 50, which in turn can suppress the light amount at the outer peripheral portion of display area E from decreasing. As such, it is possible to suppress the display uniformity of display area E from decreasing.

A display device in Example 5 is the display device according to Example 4, in which the plurality of light sources 60 include (i) light source 62 on the outer side located in at least a portion of outer peripheral area 52 that is within an area where the plurality of light sources 60 are arranged and (ii) light source 61 on the inner side located inward from light source 62 on the outer side. Distance d2 between optical axis 60a of light source 62 on the outer side and optical axis 60a of light source 61 on the inner side adjacent to light source 62 on the outer side may be greater than distance d1 between optical axes 60a of two adjacent light sources 61 on the inner side.

By setting distance d2>distance d1 as described above with regard to the distance between optical axes 60a of light sources 60, the width of light emitted by light source 62 on the outer side and passing through and exiting optical element 72 on the outer side becomes larger. Thus, it is possible to expand irradiation area L of backlight device 50, which in turn can suppress the light amount at the outer peripheral portion of display area E from decreasing. As such, it is possible to suppress the display uniformity of display area E from decreasing.

A display device in Example 6 includes: backlight device 50 including a plurality of light sources 60 arranged in a two-dimensional array and a plurality of optical elements 70 having a one-to-one correspondence with the plurality of light sources 60; and display panel 40 that outputs an image on the basis of light emitted by backlight device 50. Each of optical elements 70 has positive power. The plurality of light sources 60 include (i) light source 62 on the outer side located in at least a portion of outer peripheral area 52 that is within an area where the plurality of light sources 60 are arranged and (ii) light source 61 on the inner side located inward from light source 62 on the outer side. The light-emitting size of light source 62 on the outer side differs from the light-emitting size of light source 61 on the inner side.

Thus, by light source 62 on the outer side and light source 61 on the inner side having different light-emitting sizes, it is possible to adjust irradiation area L of backlight device 50 and the light amount of display area E of the display device. As such, it is possible to suppress the display uniformity of display area E from decreasing.

A display device in Example 7 is the display device according to Example 6, in which the light-emitting size of light source 62 on the outer side may be greater than the light-emitting size of light source 61 on the inner side.

In this way, by increasing the light-emitting size of light source 62 on the outer side, it is possible to expand irradiation area L of backlight device 50, which in turn can suppress the light amount at the outer peripheral portion of display area E from decreasing. As such, it is possible to suppress the display uniformity of display area E from decreasing.

A display device in Example 8 is the display device according to any one of Examples 1 to 7, in which optical element 70 may be a lens, optical element 72 on the outer side may include (i) inner portion 72a located closer to optical element 71 on the inner side than optical axis 70a of optical element 71 on the outer side is and (ii) outer portion 72b located on the opposite side from optical element 71 on the inner side, and the power of outer portion 72b may be lower than the power of inner portion 72a.

In this way, by decreasing the power of outer portion 72b of optical element 72 on the outer side, it is possible to expand irradiation area L of backlight device 50, which in turn can suppress the light amount at the outer peripheral portion of display area E from decreasing. As such, it is possible to suppress the display uniformity of display area E from decreasing.

A display device in Example 9 is the display device according to Example 8, in which when backlight device 50 is viewed in a direction along optical axis 70a of optical element 70, the curvature of the perimeter of outer portion 72b may be smaller than the curvature of the perimeter of inner portion 72a.

In this way, it is possible to set the power of outer portion 72b of optical element 72 on the outer side to lower power. Thus, it is possible to expand irradiation area L of backlight device 50, which in turn can suppress the light amount at the outer peripheral portion of display area E from decreasing. As such, it is possible to suppress the display uniformity of display area E from decreasing.

A display device in Example 10 is the display device according to any one of Examples 1 to 7, in which the effective size of optical element 72 on the outer side may differ from the effective size of optical element 71 on the inner side.

Thus, by optical element 72 on the outer side and optical element 71 on the inner side having different effective sizes, it is possible to adjust irradiation area L of backlight device 50 and the light amount of display area E of the display device. As such, it is possible to suppress the display uniformity of display area E from decreasing.

A display device in Example 11 is the display device according to Example 10, in which the effective size of optical element 72 on the outer side may be greater than the effective size of optical element 71 on the inner side.

In this way, by increasing the light-emitting size of optical element 72 on the outer side, it is possible to expand irradiation area L of backlight device 50, which in turn can suppress the light amount at the outer peripheral portion of display area E from decreasing. As such, it is possible to suppress the display uniformity of display area E from decreasing.

A display device in Example 12 is the display device according to any one of Examples 1 to 7, in which the plurality of light sources 60 may include (i) light source 62 on the outer side located in at least a portion of outer peripheral area 52 that is within an area where the plurality of light sources 60 are arranged and (ii) light source 61 on the inner side located inward from light source 62 on the outer side, and the light-emitting power of light source 62 on the outer side may be greater than the light-emitting power of light source 61 on the inner side.

In this way, by setting the light-emitting power of light source 62 on the outer side to higher power, it is possible to suppress the light amount at the outer peripheral portion of display area E from decreasing. As such, it is possible to suppress the display uniformity of display area E from decreasing.

A display device in Example 13 is the display device according to any one of Examples 1 to 12, in which optical element 72 on the outer side includes TIR part 76 for taking in light emitted by light source 62 on the outer side. TIR part 76 may be provided on the side where light incident surface 73 of optical element 72 on the outer side is present.

Thus, by optical element 72 on the outer side including TIR part 76, it is possible to suppress the light amount at the outer peripheral portion of display area E from decreasing. As such, it is possible to suppress the display uniformity of display area E from decreasing.

A display device in Example 14 is the display device according to any one of Examples 1 to 13, and further includes angle adjustable lens 80 disposed between backlight device 50 and display panel 40. Angle adjustable lens 80 may change the angle of light emitted by backlight device 50 according to the angle of the light, and output, toward display panel 40, the light whose angle has been changed.

As such, it is possible to suppress the display uniformity of display area E from decreasing.

A head-up display apparatus 2 in Example 15 includes the display device according to any one of Examples 1 to 14.

Thus, it is possible to provide head-up display apparatus 2 including the display device capable of suppressing the display uniformity of display area E from decreasing.

### Other Embodiments

The display devices and head-up display apparatus according to one or more aspects are described above on the basis of the above embodiments. However, the present disclosure is not limited to the above embodiments. Within the scope of the present disclosure, the one or more aspects may include embodiments obtained by adding various changes envisioned by those skilled in the art to the above embodiments and embodiments created by combining the structural elements described in different embodiments.

In the above, as a non-limiting example, the following example is described: in each of the X-axis direction and Y-axis direction, optical elements 72 on the outer side and optical elements 71 on the inner side are provided, and light sources 62 on the outer side and light sources 61 on the inner side are provided. For instance, backlight device 50 may be configured to include optical elements 72 on the outer side and optical elements 71 on the inner side only in the X-axis direction, and include light sources 62 on the outer side and light sources 61 on the inner side only in the X-axis direction. For instance, backlight device 50 may be configured to include optical elements 72 on the outer side and optical elements 71 on the inner side only in the Y-axis direction, and include light sources 62 on the outer side and light sources 61 on the inner side only in the Y-axis direction.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2024-192071 filed on Oct. 31, 2024.

### INDUSTRIAL APPLICABILITY

A display device according to the present disclosure is applicable to, for example, a picture generation unit (PGU) included in, for example, a head-up display apparatus.

1. A display device comprising:
a backlight device including:
a plurality of light sources arranged in a two-dimensional array; and
a plurality of optical elements having a one-to-one correspondence with the plurality of light sources; and
a display panel that outputs an image based on light emitted by the backlight device, wherein
each of the plurality of optical elements has power that is positive,
the plurality of optical elements include (i) an optical element on an outer side located in at least a portion of an outer peripheral area that is within an area where the plurality of optical elements are arranged and (ii) an optical element on an inner side located inward from the optical element on the outer side, and
the power of the optical element on the outer side differs from the power of the optical element on the inner side.

2. The display device according to claim 1, wherein
the power of the optical element on the outer side is lower than the power of the optical element on the inner side.

3. A display device comprising:
a backlight device including:
a plurality of light sources arranged in a two-dimensional array; and
a plurality of optical elements having a one-to-one correspondence with the plurality of light sources; and
a display panel that outputs an image based on light emitted by the backlight device, wherein
each of the plurality of optical elements has power that is positive,
the plurality of optical elements include (i) an optical element on an outer side located in at least a portion of an outer peripheral area that is within an area where the plurality of optical elements are arranged and (ii) an optical element on an inner side located inward from the optical element on the outer side, and
a distance between an optical axis of the optical element on the outer side and an optical axis of the optical element on the inner side adjacent to the optical element on the outer side differs from a distance between optical axes of two adjacent optical elements on the inner side, each being the optical element on the inner side.

4. The display device according to claim 3, wherein
the distance between the optical axis of the optical element on the outer side and the optical axis of the optical element on the inner side adjacent to the optical element on the outer side is greater than the distance between the optical axes of the two adjacent optical elements on the inner side.

5. The display device according to claim 4, wherein
the plurality of light sources include (i) a light source on the outer side located in at least a portion of an outer peripheral area that is within an area where the plurality of light sources are arranged and (ii) a light source on the inner side located inward from the light source on the outer side, and
a distance between an optical axis of the light source on the outer side and an optical axis of the light source on the inner side adjacent to the light source on the outer side is greater than a distance between optical axes of two adjacent light sources on the inner side, each being the light source on the inner side.

6. A display device comprising:
a backlight device including:
a plurality of light sources arranged in a two-dimensional array; and
a plurality of optical elements having a one-to-one correspondence with the plurality of light sources; and
a display panel that outputs an image based on light emitted by the backlight device, wherein
each of the plurality of optical elements has power that is positive,
the plurality of light sources include (i) a light source on an outer side located in at least a portion of an outer peripheral area that is within an area where the plurality of light sources are arranged and (ii) a light source on an inner side located inward from the light source on the outer side, and
a light-emitting size of the light source on the outer side differs from a light-emitting size of the light source on the inner side.

7. The display device according to claim 6, wherein
the light-emitting size of the light source on the outer side is greater than the light-emitting size of the light source on the inner side.

8. The display device according to claim 1, wherein
each of the plurality of optical elements is a lens, and
the optical element on the outer side includes (i) an inner portion located closer to the optical element on the inner side than an optical axis of the optical element on the outer side is and (ii) an outer portion located on an opposite side from the optical element on the inner side, and
power of the outer portion is lower than power of the inner portion.

9. The display device according to claim 8, wherein
when the backlight device is viewed in a direction along an optical axis of the optical element, a curvature of a perimeter of the outer portion is smaller than a curvature of a perimeter of the inner portion.

10. The display device according to claim 1, wherein
an effective size of the optical element on the outer side differs from an effective size of the optical element on the inner side.

11. The display device according to claim 10, wherein
the effective size of the optical element on the outer side is greater than the effective size of the optical element on the inner side.

12. The display device according to claim 1, wherein
the plurality of light sources include (i) a light source on the outer side located in at least a portion of an outer peripheral area that is within an area where the plurality of light sources are arranged and (ii) a light source on the inner side located inward from the light source on the outer side, and
light-emitting power of the light source on the outer side is greater than light-emitting power of the light source on the inner side.

13. The display device according to claim 12, wherein
the optical element on the outer side includes a total internal reflection (TIR) part for taking in light emitted by the light source on the outer side, and
the TIR part is provided on a side where a light incident surface of the optical element on the outer side is present.

14. The display device according to claim 1, further comprising:
an angle adjustable lens disposed between the backlight device and the display panel, wherein
the angle adjustable lens changes an angle of light emitted by the backlight device according to the angle of the light, and outputs, toward the display panel, the light whose angle has been changed.

15. A head-up display apparatus comprising the display device according to claim 1.

16. The display device according to claim 3, wherein
each of the plurality of optical elements is a lens, and
the optical element on the outer side includes (i) an inner portion located closer to the optical element on the inner side than an optical axis of the optical element on the outer side is and (ii) an outer portion located on an opposite side from the optical element on the inner side, and
power of the outer portion is lower than power of the inner portion.

17. The display device according to claim 6, wherein
each of the plurality of optical elements is a lens, and
the optical element on the outer side includes (i) an inner portion located closer to the optical element on the inner side than an optical axis of the optical element on the outer side is and (ii) an outer portion located on an opposite side from the optical element on the inner side, and
power of the outer portion is lower than power of the inner portion.

18. The display device according to claim 3, wherein
an effective size of the optical element on the outer side differs from an effective size of the optical element on the inner side.

19. The display device according to claim 6, wherein
an effective size of the optical element on the outer side differs from an effective size of the optical element on the inner side.

20. The display device according to claim 3, wherein
the plurality of light sources include (i) a light source on the outer side located in at least a portion of an outer peripheral area that is within an area where the plurality of light sources are arranged and (ii) a light source on the inner side located inward from the light source on the outer side, and
light-emitting power of the light source on the outer side is greater than light-emitting power of the light source on the inner side.

21. The display device according to claim 6, wherein
the plurality of light sources include (i) a light source on the outer side located in at least a portion of an outer peripheral area that is within an area where the plurality of light sources are arranged and (ii) a light source on the inner side located inward from the light source on the outer side, and
light-emitting power of the light source on the outer side is greater than light-emitting power of the light source on the inner side.
